(19) United States
(12) Patent Application Publication
(10) Pub. No.: US 2017/0073226 A1
(43) Pub. Date: Mar. 16, 2017

(54) METHOD FOR PRODUCING HYDROGEN-CONTAINING GAS AND REACTOR FOR IMPLEMENTING SAID METHOD

(71) Applicants: Vladimir Z. MORDKOVICH, Moscow (RU); Igor Vladimirovich DEREVICH, Moscow (RU); Vadim Sergeevich ERMOLAEV, Moscow (RU); Ilia Sergeevich ERMOLAEV, Moscow (RU); Eduard Borisovich MITBERG, Moscow (RU); Igor Grigorievich SOLOMONIK, Moscow (RU); Petr Ivanovich KULCHAKOVSKY, Moscow (RU); Infra Carbon Limited, Limassol (CY)

(72) Inventors: Vladimir Z. Mordkovich, Moscow (RU); Igor V. Derevich, Moscow (RU); Vadim S. Ermolaev, Moscow (RU); Ilia S. Ermolaev, Moscow (RU); Eduard B. Mitberg, Ekaterinburg (RU); Igor G. Solomonik, Moscow (RU); Petr I. Kulchakovsky, Obninsk (RU)

(21) Appl. No.: 15/125,197

(22) PCT Filed: Mar. 19, 2015
(86) PCT No.: PCT/RU2015/000160

§ 371 Date: Sep. 12, 2016

(30) Foreign Application Priority Data
Mar. 20, 2014 (RU) 2014110691

(51) Int. Cl. C01B 3/36; B01J 19/02; B01J 7/00

(52) U.S. Cl. CPC C01B 3/36; B01J 7/00; B01J 19/02; C01B 2203/0255; C01B 2203/0883; C01B 2203/1241; B01J 2219/02

(57) ABSTRACT

The invention is for use in gas chemistry for producing hydrogen-containing gas on the base of a CO and H₂ mixture (syngas) from natural gas and other hydrocarbon gases. The object of the invention is to suppress side reactions resulting in soot formation when conducting the process in high productivity mode, and also to provide for an uncomplicated reactor design while maintaining compact dimensions thereof. The method for producing a hydrogen-containing gas comprises mixing natural gas with oxygen, partially oxidizing the natural gas with oxygen at a temperature ranging from 1300° C. to 1700° C. resulting in obtaining hydrogen-containing gas, and cooling the stream of the hydrogen-containing gas produced. Said cooling is performed until the temperature drops below 550° C. and at a rate above 100000° C./sec. The reactor comprises the following steps, which are arranged in series along the technological process: means for supplying natural gas and oxygen, a natural gas and oxygen mixing zone, a zone for conducting the reaction by partially oxidizing the natural gas with oxygen, and a zone for cooling the stream of the hydrogen-containing gas produced, which is equipped with a cooling body of revolution in order to provide an intensive cooling of the stream of hydrogen-containing gas by contacting thereof with said body of revolution.

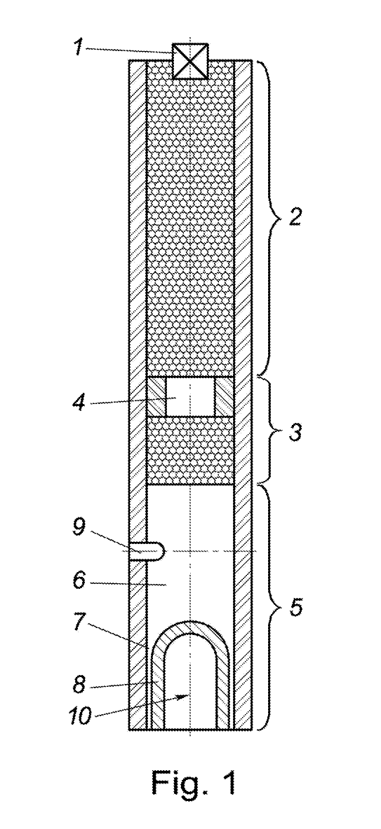

### FIELD OF THE INVENTION

The present invention relates to the field of gas chemistry and can be used to produce hydrogen-containing gas on the base of a mixture of CO and H₂ (syngas) from natural gas and other hydrocarbon gases.

### BACKGROUND OF THE INVENTION

Processes for producing hydrogen-containing gas from natural gas has been used in industry since the beginning of the XX century and are based on partial oxidation of methane with oxygen, water steam, or carbon dioxide. Various combinations of these processes (steam-carbon dioxide conversion, autothermal reforming) are also known.

A partial oxidation process is currently most promising, because it enables to produce a syngas with a component ratio required to carry out a number of large-tonnage processes, such as a methanol synthesis or Fisher-Tropsch synthesis. Processes known in the prior art commonly require the use of a catalyst. For example, systems Ru/Al₂O₃, Pt/Al₂O₃, Pd/Al₂O₃, Ni/Al₂O₃, Rh/MgO and Rh/ZrO₂ are catalysts for partial oxidation process (o. V. Krylov “Heterogeneous catalysis”, M., Academkniga, 2004, pp. 605-606).

Simpler homogeneous process without the use of a catalyst is possible, but it requires to carry out a reaction at temperatures more than 1300° C., at which chemical equilibrium is shifted to the side of the formation of CO and H₂. Such non-catalytic process was developed in the middle of the last century and is combustion of hydrocarbons in a flow of oxidant in an unconfined space. By now, modifications of this process, for example, with the use of plasma, are developed (Xing Rao et al. Combustion Dynamics of Plasma-Enhanced Premixed and Nonpremixed Flames, Transactions on plasma science, vol. 38, no. 12, December 2010, pp. 3265-3271), but they find no practical application.

Main reactions observed in the process are the following:

CH₄+½O₂═CO+2H₂

CO+H₂═C+H₂O

CH₄+2O₂═CO₂+2H₂O

H₂+½O₂═H₂O

CO+½O₂═CO₂

The above-mentioned system of reactions shows that products of the process may be, except hydrogen and carbon monoxide, carbon (soot), water and carbon dioxide, that are undesirable by-products of the process. It is known from the existing kinetic models of soot formation that a characteristic time of soot particles formation is more than 5 ms (Oleg A. Louchev, Thomas Laude, Yoichiro Sato, and Hisao Kanda. Diffusion-controlled kinetics of carbon nanotube forest growth by chemical vapor deposition, Journal of chemical physics, vol. 118, no. 16, April 2003, pp. 7622-7634).

Main requirements for the process of hydrogen-containing gas formation and related device are high productivity and small size of a reactor, adequate mixing of a feed gas and oxidizing gas to prevent formation of local centres of detonation and provide the flame stabilization, suppressing side reactions of formation of carbon, water and carbon dioxide.

It is known that a thermal partial oxidation process can be technologically implemented in a reactor, in which reaction products are cooled through the convective heat transfer, expansion of reaction products and use of a drip curtain (cooling with water).

Reactors with the drip curtain used as the means of cooling reaction products are currently most promising due to main design solutions studied in detail. Such reactors have successively arranged reaction zone (combustion zone) and combustion products cooling zone that is also washing zone enabling to remove the soot formed in side reactions. In the reactor, both chemical reactions in an unconfined space and physical processes occur simultaneously, where physical processes are heat transfer from reaction products to a heat transfer agent and evaporation of the heat transfer agent, process of non-selective physical absorption, in which side reaction products, such as soot, carbon dioxide etc., are generally absorbed.

One of the main problems faced by persons skilled in the art when designing reactors for non-catalytic high-temperature partial oxidation used to produce hydrogen-containing gas are side reactions of soot formation during chemical reaction in the combustion zone as well as during the subsequent cooling reaction products. In the first case, the reactions of soot formation take place in the outer layer of the flame characterized by lower temperatures, and these reactions, generally during partial oxidation of methane-rich hydrocarbon gases, are insignificant because of extremely short residence times of reagents in the reaction zone. In the second case, when the product cooling rate is not high enough, soot particles are formed in the significant amount and accumulated in the reactor system, that lead to reduction in the reactor system lifetime. Furthermore, the formation of soot particles have an effect on the H₂/CO ratio and, therefore, on a composition of the produced syngas. This is because, though the formation of soot is possible at temperatures below 700° C., it is kinetically limited, and at temperatures higher 1300° C., equilibrium of reactions of soot formation is rapidly shifted to the side of reagents, and only at intermediate temperatures (700-1300° C.), a probability of the growth of soot particles is high enough.

Another problem of most reactors is a complexity of design of assembly for cooling products as well as a need to use special materials because of high temperatures of reaction (higher 1300° C.) and an aggressive corrosive medium. The use of such special structural materials results in significant increase in cost of reactor and special requirements for maintenance and repair of the reactor, and moreover, the reactor lifetime is significantly decreased.

A method for producing syngas by non-catalytic partial oxidation is described and known as SGP (Shell Gasification Process), see C. J. Kuhre, et al. Partial Oxidation Grows Stronger in U.S., Oil and Gas Journal, vol. 69, No. 36, Sep. 6, 1971.).

This method comprises the use of a burner particularly selected for each type of oxidized feedstock, carrying out the oxidation process in the hollow cylindrical steel reactor with refractory lining at increased pressures (up to 58 atm), and cooling reaction products by heat exchange with water through the wall of the outer boiler having special design, which prevents carbonization of the heat exchange surface, thereby providing no decrease in the heat transfer coefficient as well as the absence of local overheat areas. Heat exchange pipes helically coiled and the specially calculated velocity of the combustion product stream enable to cool the syngas with high content of soot (up to 3 wt. %), which syngas is produced for using as the feedstock of heavy fuels, as well as to provide a long operation period without shutdown for maintenance of the device. The main disadvantages of said method are the need for strictly predetermined composition of the feedstock to maintain thermal conditions of the process and the presence of soot in the reaction products.

The method and device for producing syngas from raw hydrocarbons and air by non-catalytic partial oxidation are known from the patent RU 2191743 C2, 2002. The method for producing syngas comprises mixing raw hydrocarbons with air, forced ignition of the air-hydrocarbons mixture, and partial oxidation of the raw hydrocarbons with atmospheric oxygen in the reaction zone that is the flow combustion chamber, where forced ignition is carried out at the oxygen to raw hydrocarbons ratio of 0.6-0.7, and said ratio is adjusted to 0.30-0.56 after heating the flow combustion chamber. Cooling the products occurs as a result of their expansion as well as convective heat exchange in the recuperative heat exchanger installed in the reactor, said recuperative heat exchanger is made in the form of system of tube heaters for heating raw hydrocarbons and air. Heat transfer agent in this system is the combustion reaction products. In addition to entering in the tube heaters, air also enters in the impermeable housing of the combustion chamber provided with insertions of refractory material, such as ceramic material, and forms the additional cooling interlayer. Said reactor design provides the cooling rate of the partial oxidation products of at least 3000° C./s, which, however, does not provides the suppression of the formation of carbon condensation products (soot). In addition to said disadvantage related to slow cooling, such reactor is difficult to manufacture and maintain. The process is carried out using air as heat transfer agent, which leads to the significant dilution of the reaction products. Moreover, the process is characterized by production of the main products, hydrogen and carbon monoxide, in the ratio 1:1.6, which does not conform to the requirements for carrying out some catalytic processes of syngas processing (e.g. the methanol synthesis or Fisher-Tropsch synthesis).

The method and device for producing syngas by the non-catalytic partial oxidation of hydrocarbons in the internal space of cylinder of internal combustion engine have been presented in the prior art. The method is that premixed raw hydrocarbons and air are heated to the temperature of 200-450° C. and fed in the engine cylinder, when the engine piston moves to the bottom dead center. When the engine piston moves to the top dead center, self-ignition of the mixture occurs with increasing the temperature to 1300-2300° C. for a time period of 10⁻²-10⁻³ s, and when the engine piston moves to the bottom dead center, the products are cooled due to their expansion and then they are removed. Said cycle is repeated with the rate more than 350 min⁻¹ (patent RU 2096313 C1, 1997). The main disadvantage of this method is that the process is not continuous because it is cyclical, i.e. the method can not be carried out with the continuous forward flow of reagents. Moreover, said device is not sufficiently reliable and durable, because its operation involves movements of main components (such as engine piston, crank and valves), which causes the wear of these components.

A method and device for producing syngas by the non-catalytic partial oxidation of hydrocarbon gases are known from the patent CN 101245263 B, 2011. In this method, leaving the combustion chamber in the form of hollow cylinder with tapered end portion and cooled jacket, obtained products enter in the cooling zone, where they successively pass through the drip curtain area, water layer and bubble trays, after which they exit from the reactor. In this case, the products not only are cooled, but also are cleaned from soot (the soot content in the obtained syngas does not exceed 1-3 ppm), but this method does not provide suppression of soot formation reactions. Said method has been selected as a closest analog of the present invention.

It should be noted that, in the mentioned known methods, the combustion of hydrocarbons occurs in the unconfined space, which is associated with increased fire and explosion hazard.

It is possible to overcome the above mentioned disadvantages by significant decreasing the cooling time of reaction products with using a device having simple and reliable design.

### SUMMARY OF THE INVENTION

A technical object of the present invention is to provide a method for producing hydrogen-containing gas on the base of a mixture of carbon monoxide and hydrogen (syngas) by non-catalytic high-temperature partial oxidation of raw hydrocarbon gases, which method ensures suppression of side reactions resulting in soot formation when conducting the process in high productivity mode. Also, an object of the present invention is to provide a reactor for carrying out said method, said reactor having uncomplicated design and compact dimensions.

Regarding the method according to the present invention, said object is achieved by providing a method for producing hydrogen-containing gas, which method comprises mixing natural gas with oxygen, partial oxidation of natural gas by oxygen at the temperature ranging from 1300° C. to 1700° C. to produce hydrogen-containing gas, and cooling the stream of obtained hydrogen-containing gas, where, according to the present invention, the stream of hydrogen-containing gas is cooled to the temperature lower 550° C. at the cooling rate more than 100000° C./s.

Said cooling rate of the stream of obtained hydrogen-containing gas provides the time of cooling said stream to the temperature lower 550° C. no more than 5 ms, which enables to carry out said method without formation of soot as by-product.

To provide said cooling rate, cooling may be carried out by contacting the stream of hydrogen-containing gas with cooled body of revolution. When contacting with the cooled body of revolution, the hydrogen-containing gas stream preferably has a linear velocity of at least 40 m/s.

To intensify the cooling process, water in the amount of at least 10 kg per 1 kg of hydrogen-containing syngas can be injected in the hydrogen-containing gas stream before contacting it with the cooled body of revolution.

To provide a fire and explosion safety for the method according to the present invention, mixing natural gas with oxygen and partial oxidation of natural gas by oxygen can be carried out in the porous medium of a refractory material that may be, for example, a ceramic material.

Regarding the reactor according to the present invention, said object is achieved by providing a reactor for producing hydrogen-containing gas, which reactor comprises successively arranged along the technological process: means for feeding of natural gas and oxygen, a natural gas and oxygen mixing zone, a reaction zone for carrying out partial oxidation of natural gas with oxygen, and a zone for cooling the stream of obtained hydrogen-containing gas, where, according to the present invention, the cooling zone is provided with a cooled body of revolution to enable intensive cooling the stream of hydrogen-containing gas by contacting said stream with said body of revolution.

The cooled body of revolution preferably has a streamline shape to prevent the formation of reverse streams, when the velocity of the hydrogen-containing gas stream is 40 m/s and higher.

To further intensify the process of cooling the hydrogen-containing gas stream, the reactor according to the present invention can be provided with at least one injector to inject water in the cooling zone upstream from the body of revolution.

To provide fire and explosion safety for the process, the mixing and reaction zones in the reactor according to the present invention can be filled up with porous refractory material.

### BRIEF DESCRIPTION OF THE DRAWINGS

The drawing schematically shows a general view of the exemplary embodiment of the reactor according to the present invention in longitudinal section.

### DETAILED DESCRIPTION OF THE INVENTION

In the embodiment shown in the drawing, the reactor for carrying out the method according to the present invention is made in the form of a vertical apparatus with the top feed of reagents, in which gas stream moves downward from the top. The reactor comprises successively arranged a means for supplying natural gas and oxygen made in the form of inlet assembly 1, a natural gas and oxygen mixing zone 2, a reaction zone 3 (zone for carrying out partial oxidation of natural gas with oxygen) comprising a combustion chamber 4, and cooling zone 5 for cooling the stream of obtained hydrogen-containing gas. The mixing zone 2 and reaction zone 3 (except the combustion chamber 4) are filled up with a porous refractory ceramic material. The cooling zone 5 comprises a first hollow and empty portion 6 and a second portion 7, in which a cooled body of revolution 8 is installed, arranged along the flow direction of the reaction products. The first portion 6 of the cooling zone 5 is provided with one ore more injectors 9 to inject water.

The method according to the present invention is carried out in the proposed reactor as follows.

Natural gas and oxygen pass through the inlet assembly 1 and enter into the mixing zone 2 filled up with the porous ceramic material, then the mixture enters into the combustion chamber 4, in which it is ignited by a spark or incandescent body, for example, a platinum filament, and then enters into the reaction zone 3, in which hydrogen-containing gas (syngas) is produced. Then, syngas is mixed with water injected through injectors 9 in the first portion 6 of the cooling zone 5 and enters into the second portion 7 of the cooling zone 5, in which the syngas is contacted with the cooled body of revolution 8, flowing around full circumference of the body of revolution 8 along its axis 10. That enables to remove the heat of the chemical reaction by convective heat transfer between syngas and cooling agent, such as water, through the wall of the cooled body of revolution 8, in which the heat transfer agent partially evaporates, thereby absorbing the transferred heat due to heat of evaporation.

As the numerous studies conducted by inventors of the present invention have shown (results of these studies are partially presented in the table below), to maintain optimum operating conditions of the reactor, at which the formation of by-products is not occurs, is possible by cooling the obtained syngas for a time no more than 5 ms, that is achieved, when the cooling rate of the syngas stream is more than 100000° C./s. To achieve these conditions, the hot hydrogen-containing gas entering in zone of flowing around the cooled body of revolution must have the velocity no less than 40 m/s.

Compared to known prior arts with the same output, the reactor according to the present invention enables the suppression of side reactions and, as a result, the formation of the cleaner product having the ratio close to stoichiometric, which is confirmed by the following examples of the embodiments of the present invention.

The following are examples of the embodiments of the non-catalytic method for producing hydrogen-containing gas by partial oxidation of natural gas with oxygen using the reactor according to the present invention at the various conditions. Examples 3, 4 and 8 relate to the method according to the present invention, and examples 1, 2, 5-7 are presented for the purpose of comparison. In all examples, reagents was fed in the reactor at the atmospheric pressure, and the density of obtained syngas was 0.065 kg/m³.

### Example 1

Oxygen and hydrocarbon gas (methane) were fed in the flow reactor in a ratio close to stoichiometric at the atmospheric pressure. The flow reactor has the inner diameter of 25 mm, its mixing zone and reaction zone are filled up with the ceramic fill, for example, ball-shaped particles of the refractory corundum. The syngas obtained by the combustion reaction at the temperature higher 1300° C. and mass flow rate of 0.0001 kg/s was mixed with water injected through the injector in the amount of 0.0011 kg/s and supplied to the cooled body of revolution having the diameter of 20 mm at the ambient temperature that was lower 30° C. At the outlet of the reactor, the gas velocity was 12.8 m/s. In this case, the syngas was cooled to the temperature lower 550° C. within 18 ms, which did not give the desired result, as the soot was formed in this cooling time.

Other examples of the embodiments of the method are analogous to example 1, except that, in the example 5, mass flow rate of the syngas conforms to conditions of supersonic flow, that inevitably lead to destruction of the reactor parts and does not allow to carry out the syngas producing process, and examples 6-8 relate to reactions carried out without adding water (drip curtain) in the cooling zone.

The examples show, that carrying out the method according to the present invention enables to solve given technical problem, i.e. to provide the production of syngas by non-catalytic high-temperature partial oxidation of raw hydrocarbon gases with the suppression of side reactions.

The examples 1-2 and 6-7 show, that when the non-optimum mass flow rate of raw material is selected, the required velocity of the stream of reaction products, not necessarily added with water, may be not achieved before contacting the stream with the cooled body of revolution, which results in increased residence time of the reaction products in the zone of flowing around the cooled body of revolution until the temperature lower 550° C. is reached as well as creates conditions for side reactions, including the soot formation reactions.

TABLE

| | Example No. | | | | | | | |
|---|---|---|---|---|---|---|---|---|
| Parameters | 1 | 2 | 3 | 4 | 5 | 6 | 7 | 8 |
| Syngas mass flow | 1 · 10⁻⁴ | 2 · 10⁻⁴ | 5 · 10⁻⁴ | 1 · 10⁻³ | 2 · 10⁻³ | 5 · 10⁻⁴ | 1 · 10⁻³ | 2 · 10⁻³ |
| rate, kg/s | | | | | | | | |
| Syngas mass flow | 0.36 | 0.72 | 1.80 | 3.60 | 7.20 | 1.80 | 3.60 | 7.20 |
| rate, kg/h | | | | | | | | |
| Syngas volume | 0.78 | 1.57 | 3.94 | 7.88 | 15.75 | 3.94 | 7.88 | 15.75 |
| flow rate nm³/h | | | | | | | | |
| Water mass flow | 0.0011 | 0.0022 | 0.0054 | 0.0108 | 0.0215 | 0 | 0 | 0 |
| rate, kg/s | | | | | | | | |
| Syngas velocity at | 12.8 | 38 | 83.3 | 204.7 | 958.3 | 7.74 | 22.4 | 57.2 |
| the outlet of the | | | | | | | | |
| reactor, m/s | | | | | | | | |
| Syngas cooling | 42000 | 74000 | 181000 | 399000 | 843000 | 57000 | 89000 | 121000 |
| rate, ° C./s | | | | | | | | |
| Composition of | 65 | 66 | 66.66 | 66.66 | * | 65 | 66 | 66.66 |
| syngas, mol. % | | | | | | | | |
| H₂ | | | | | | | | |
| CO | 32 | 33 | 33.33 | 33.33 | | 32 | 33 | 33.33 |
| CO₂ and H₂O | balance | balance | balance | balance | | balance | balance | balance |
| Content of | >0.5 | traces | not | not | * | 0.5 | traces | not |
| soot, % w/w | | | | | | | | |

* Syngas velocity at the outlet of the reactor is more than the sound velocity, which does not allow to carry out the process because of destruction of the reactor parts at these conditions.

1. A method for producing hydrogen-containing gas, said method comprising mixing natural gas with oxygen, partial oxidation of natural gas by oxygen at the temperature ranging from 1300° C. to 1700° C. to produce hydrogen-containing gas, and cooling the stream of obtained hydrogen-containing gas, where the stream of hydrogen-containing gas is cooled to the temperature lower 550° C. at the cooling rate more than 100000° C./s.

2. The method according to claim 1, where cooling the stream of hydrogen-containing gas is carried out by contacting said stream with a body of revolution.

3. The method according to claim 2, where the stream of hydrogen-containing gas has a linear velocity of at least 40 m/s when contacting with the cooled body of revolution.

4. The method according to claim 2, where water in the amount of at least 10 kg per 1 kg of hydrogen-containing syngas is injected in the stream of hydrogen-containing gas before contacting said stream with the cooled body of revolution.

5. The method according to claim 1, where mixing natural gas with oxygen and partial oxidation of natural gas by oxygen are carried out in a porous medium of a refractory material.

6. The method according to claim 5, where the refractory material is a ceramic material.

7. A reactor for producing hydrogen-containing gas, said reactor comprising successively arranged along the technological process: a means for feeding of natural gas and oxygen, a natural gas and oxygen mixing zone, a reaction zone for carrying out partial oxidation of natural gas with oxygen, and a zone for cooling the stream of obtained hydrogen-containing gas, where the cooling zone is provided with a cooled body of revolution to enable intensive cooling the stream of hydrogen-containing gas by contacting said stream with said body of revolution.

8. The reactor according to claim 7, where the cooled body of revolution has a streamline shape.

9. The reactor according to claim 7, where the reactor is provided with at least one injector to inject water in the cooling zone upstream from the body of revolution.

10. The reactor according to claim 7, where the mixing zone and reaction zone are filled up with porous refractory material.
